(19) United States
(12) Patent Application Publication
(10) Pub. No.: US 2026/0056339 A1
(43) Pub. Date: Feb. 26, 2026

(54) METHOD, DEVICE AND SYSTEM FOR MONITORING TRAFFIC AND ROAD CONDITIONS WITH SEISMIC DATA

(71) Applicant: BAFANG SEISMIC INC., Shenzhen, Guangdong (CN)

(72) Inventors: Jie ZHANG, Shenzhen, Guangdong (CN); Tong Wang FEI, Shenzhen, Guangdong (CN); Ziyu LI, Shenzhen, Guangdong (CN); Miao YU, Shenzhen, Guangdong (CN); Yi LUO, Shenzhen, Guangdong (CN); Lucas Xing FEI, Shenzhen, Guangdong (CN)

(21) Appl. No.: 18/876,902

(22) PCT Filed: Mar. 21, 2024
(86) PCT No.: PCT/CN2024/082961

§ 371 Date: Dec. 19, 2024

(51) Int. Cl. G01V 1/28; G01V 1/30; G08G 1/017; G08G 1/052

(52) U.S. Cl. CPC G01V 1/288; G01V 1/30; G01V 2210/123; G08G 1/017; G08G 1/052

(57) ABSTRACT

A method, device and system of monitoring traffic and road conditions with seismic data. Specifically, a method for monitoring traffic flow with seismic data may include: obtaining, from seismic recording devices, the seismic data; obtaining a seismic data fluctuation graph based on the seismic data, wherein the seismic data fluctuation graph includes a plurality of seismic data fluctuation curves for each of the seismic recording devices; and monitoring the traffic flow based on the seismic data fluctuation graph.

### CROSS-REFERENCE TO RELATED APPLICATION

This application is a Section 371 National Stage Application of International Application No. PCT/CN2024/082961, filed on Mar. 21, 2024, entitled “METHOD, DEVICE AND SYSTEM FOR MONITORING TRAFFIC AND ROAD CONDITIONS WITH SEISMIC DATA”, the content of which is hereby incorporated by reference in its entirety.

### TECHNICAL FIELD

The present invention relates generally to a field of data processing, and specifically, to a method, system, electric device, a non-temporary computer-readable storage medium storing instructions and a computer program product for monitoring traffic and road conditions, predicting traffic accident with time series data, such as seismic data from seismic waves.

### BACKGROUND

Road accidents are one of the leading causes of death in the world. According to the World Health Organization (WHO), it is estimated that around 1.3 million deaths occur every year due to auto accidents. In the United States, the Centers for Disease Control and Prevention (CDC) reports that deaths are 3 to 10 times higher in rural areas compared to urban areas and account for around 45% of traffic fatalities in 2019. Accidents on these roads usually take longer to be reported. Therefore, it would be beneficial to use a traffic detection system and method to monitor these roads.

Monitoring traffic flow on multiple roads or in the entire city is critical for traffic control authority to identify any issue or problem in real-time. With the emergence of autonomous vehicles, the demand for real-time traffic flow information becomes urgent. The traffic flow information offers an opportunity for vehicle roadway traffic density management systems and methods that automatically optimize the spacing between and among autonomous vehicles on roadways, relative to other autonomous vehicles and/or non-autonomous vehicles. More particularly, it is possible to automatically control the operation of autonomous vehicles to maintain optimal spacing relative to leading and trailing vehicles.

Currently, there are several different methods being used to detect vehicles, including video image processing, using radar and ultrasonic sensors. Using a massive number of camera systems along the roadside should offer detailed information on both traffic flow and any individual vehicle.

However, there are many problems when using a massive number of cameras to monitor traffic and road conditions:
(1) Because of the long distances rural roads cover, one primary reason these systems are impractical is their immense cost. Each traffic camera usually costs tens of thousands dollars and to cover the vast distance would require many of these cameras or sensors.
(2) For quickly understanding the current traffic situation, accessing a large amount of video data and extracting useful information from that large data may demand significant computational efforts in real-time and expensive equipment cost.
(3) In addition, there have been many new legislations in many regions or countries that prohibit or limit the use of video recordings in the public because of the privacy concerns.

Using location services of mobile phones in vehicles as presently applied in many navigation systems may not offer accurate traffic information.

Therefore, it is expected to provide a new traffic and road monitoring method to solve the existing technical problems as mentioned above.

### SUMMARY

A first aspect of the present application provides a method for monitoring traffic flow with seismic data, the method may comprise:
obtaining, from seismic recording devices, the seismic data;
obtaining a seismic data fluctuation graph based on the seismic data, wherein the seismic data fluctuation graph comprises a plurality of seismic data fluctuation curves for each of the seismic recording devices; and
monitoring the traffic flow based on the seismic data fluctuation graph.

According to the first aspect, wherein the seismic recording devices are arranged at a fixed or variable interval on one side of a road, on both sides of the road, or in the middle of the road or any combination thereof.

According to the first aspect, wherein the obtaining of the seismic data fluctuation graph based on the seismic data may comprise: performing a signal enhancement on the seismic data.

According to the first aspect, wherein the obtaining of the seismic data fluctuation graph based on the seismic data may further comprise: performing a two-way traffic wavefield separation or attenuation on the seismic data after the signal enhancement.

According to the first aspect, wherein the obtaining of the seismic data fluctuation graph based on the seismic data may further comprise: performing balancing on the seismic data by using a correction curve after the two-way traffic wavefield separation or attenuation; and obtaining the seismic data fluctuation graph based on the balanced seismic data.

According to the first aspect, wherein the method may further comprise: obtaining a vehicle speed spectrum based on the seismic data fluctuation graph, wherein the vehicle speed spectrum is used to visually display a motion status of a vehicle.

According to the first aspect, wherein the method may further comprise: determining a vehicle speed and/or a vehicle moving path for the vehicle based on the similarity between seismic data from different seismic recording devices.

According to the first aspect, wherein the method may further comprise: determining whether the vehicle is overspeed based on the vehicle speed.

According to the first aspect, wherein the method may further comprise: determining a type and a weight of a vehicle based on a peak for the vehicle in each of plurality of seismic data fluctuation curves.

According to the first aspect, wherein the method may further comprise: determining whether the vehicle is stopping based on the vehicle moving path.

According to the first aspect, wherein the method may further comprise: determining whether there is a pedestrian walking on roads based on the seismic data.

According to the first aspect, wherein the method may further comprise: detecting whether there is an object falling from a vehicle based on the seismic data.

A second aspect of the present application provides a system for monitoring traffic flow with seismic data, the system may comprise:
seismic recording devices configured to obtain the seismic data;
a data processing module configured to obtain a seismic data fluctuation graph based on the seismic data, wherein the seismic data fluctuation graph comprises a plurality of seismic data fluctuation curves for each of the seismic recording devices; and
an analyzing module configured to analyze the traffic flow based on the seismic data fluctuation graph.

According to the second aspect, wherein the analyzing module is further configured to perform the methods of the first aspect.

A third aspect of the present application provides a system for monitoring traffic flow with seismic data, the system may comprise:
seismic recording devices configured to obtain the seismic data;
a processor;
a memory connected to the processor,
wherein the memory stores instructions, when executed by the processor, causing the processor to:
obtain a seismic data fluctuation graph based on the seismic data, wherein the seismic data fluctuation graph comprises a plurality of seismic data fluctuation curves for each of the seismic recording devices; and
monitor the traffic flow based on the seismic data fluctuation graph.

A fourth aspect of the present application provides a method for training a vehicle recognition model, the method may comprise:
obtaining a first image including a vehicle from a video;
converting the first image into a second image, representing the vehicle and a lane in which the vehicle is driving, wherein the second image is used as a training label;
obtaining a first seismic data corresponding to the first image from seismic data; and
training the vehicle recognition model based on the first seismic data and the second image.

A fifth aspect of the present application provides a vehicle recognition method, the method may comprise:

inputting seismic data to be identified into a vehicle recognition model to determine a vehicle and a lane on which the vehicle is driving,
wherein the vehicle recognition model is trained using the method according to the fourth aspect.

A sixth aspect of the present application provides a method for training a vehicle recognition model, the method may comprise:
picking seismic data within a plurality of time windows, as labels;
identifying a maximum peak or a Gaussian distribution peak of each of the labels;
determining a location of a vehicle corresponding to the maximum peak or the Gaussian distribution peak; and
training the vehicle recognition model based on the location and the corresponding maximum peak or Gaussian distribution peak.

A seventh aspect of the present application provides a vehicle recognition method, the method may comprise:
inputting seismic data to be identified into a vehicle recognition model to determine a location of a vehicle; and
determining a vehicle speed and/or a vehicle moving path of the vehicle based on the location,
wherein the vehicle recognition model is trained using the method according to the sixth aspect.

An eighth aspect of the present application provides a method for monitoring a geological condition under a road with seismic data, the method may comprise:
obtaining, from seismic recording devices, target seismic data and reference seismic data;
generating a target Green's function based on the target seismic data;
generating a reference Green's function based on the reference seismic data;
generating a near-surface relative velocity change based on the target Green's function and the reference Green's function to monitor the geological condition under the road.

According to the eighth aspect, the method may further comprise: performing signal preprocessing, noise elimination, resampling, data shift correction and filtering on the target seismic data and the reference seismic data.

According to the eighth aspect, wherein the filtering comprises multi-frequency range (f₁ᵢ, f₂ᵢ) bandpass filtering, where f₀<f₁ᵢ<f₁;f₀<f₂ᵢ<f₁; f₀ and f₁ are the lower and upper limit of a frequency range of the seismic recording devices.

According to the eighth aspect, the method may further comprise:
extracting one or more types of body wave, elastic P-wave, S-wave, SH-wave, surface wave, coda wave, Rayleigh wave and Love wave from each of the target seismic data and the reference seismic data; and
generating the reference Green's function and the target Green's function based on the extracted waves.

According to the eighth aspect, wherein the generating of the near-surface relative velocity change may comprise: generating the near-surface relative velocity change based on the target Green's function and the reference Green's function by using an ambient noise imaging method.

A ninth aspect of the present application provides a method for monitoring a road surface condition with seismic data, the method may comprise:
obtaining, from seismic recording devices, target seismic data and reference seismic data;
calculating, based on the reference seismic data, a first total energy of passing vehicles within a first frequency range at a reference time;
calculating, based on the target seismic data, a second total energy of passing vehicles within a first frequency range at a target time; and
monitoring the road surface condition based on the first total energy and the second total energy.

According to the ninth aspect, wherein the calculating of the first total energy and the calculating of the second total energy are performed in frequency domain or time domain.

According to the ninth aspect, wherein the calculating of the first total energy and the calculating of the second total energy are performed in a plurality of frequency bands.

According to the ninth aspect, wherein the monitoring of the road surface condition based on the first total energy and the second total energy may comprise: calculating a first ratio of the first total energies for the plurality of frequency bands and calculating a second ratio of the second total energies for the plurality of frequency bands; and applying a weighted summation and/or subtraction on the first ratio and the second ratio.

A tenth aspect of the present application provides a method for predicting traffic accident, the method may comprise:
obtaining, from seismic recording devices, seismic data;
obtaining information about a vehicle based on the seismic data;
predicting traffic accident based on the information about the vehicle, current and history road information, information about a driver and the weather.

An eleventh aspect of the present application provides a method for training a traffic accident prediction model, the method may comprise:
obtaining seismic data, information about a vehicle, a road, a driver and a weather when an accident happens; and
training the traffic accident prediction model based on the seismic data and the information.

A twelfth aspect of the present application provides a method for predicting traffic accident, the method may comprise:
inputting seismic data to be identified into a traffic accident prediction model for predicting traffic accident to obtain a score for the traffic accident,
wherein the traffic accident prediction model is trained using the method according to the eleventh aspect.

A thirteenth aspect of the present application provides a method for training a vehicle weight model, the method may comprise:
obtaining a peak for a vehicle from seismic data; and
training the vehicle weight prediction model based on the peak and a weight for the vehicle.

A fourteenth aspect of the present application provides a method for obtaining a weight of a vehicle, the method may comprise:
inputting seismic data to be identified into a vehicle weight model to obtain the weight of the vehicle,
wherein the vehicle weight model is trained using the method according to the thirteenth aspect.

A fifteenth aspect of the present application provides an electronic device, the electronic device may comprise:
at least one processor; and
a memory connected in communication with at least one processor,
wherein the memory stores instructions, when executed by at least one processor, causing at least one processor to perform the above methods.

A sixteenth aspect of the present application provides a non-temporary computer-readable storage medium storing instructions, when executed on a computer, causing the computer to execute the above methods.

A seventeenth aspect of the present application provides a computer program product comprising a computer program with instructions. When executed by a computer, these instructions cause the computer to perform the above methods.

### BRIEF DESCRIPTIONS OF THE DRAWINGS

The above and other aspects, features, and attendant advantages of the present disclosure will be more apparent and readily appreciated from the following detailed description, taken in conjunction with the accompanying drawings, in which like reference numerals refer to like elements, and wherein:

FIG. 1 is a schematic diagram of a system architecture for performing a traffic and road monitoring method according to an example embodiment of the present disclosure;

FIG. 2 is a schematic flowchart illustrating a method for monitoring traffic flow according to an example embodiment of the present disclosure;

FIG. 3 shows a schematic diagram of several example designs of recording positions of seismic sensors along a road for monitoring traffic;

FIG. 4 shows a schematic flowchart of processing the seismic data;

FIGS. 5A-5C show diagrams of surface-consistent amplitude corrections;

FIG. 6 shows a diagram after bandpass signal processing;

FIG. 7 shows the vehicle speed spectrum generated from bandpass signal processed data;

FIG. 8 shows a diagram for generating vehicle speed spectrum from signal enhanced traffic data;

FIG. 9 shows vehicle path and the extraction of vehicle speed from the speed spectrum;

FIG. 10 shows a diagram used to determine whether the vehicle is overspeed;

FIG. 11 shows interpretation of vehicle type, speed and weight in relationship with seismic amplitude;

FIG. 12 shows a diagram illustrating vehicle stopping;

FIG. 13 illustrates a single vehicle moving path (as indicated by the curve) along the road

FIG. 14 shows a typical seismic response of a vehicle;

FIG. 15 gives the seismic response of people walking on the highway (as indicated within an area);

FIG. 16 shows the extrapolation of the speed spectrum in spatial domain;

FIG. 17 is a structural diagram of a system 1700 for monitoring traffic flow with seismic data according to the embodiments;

FIG. 18 shows conversion from the first video image into the second dual-color image, wherein (a) shows video recordings of the road and using image/video recognition techniques to detect vehicles, and (b) shows training labels generated by using the detected vehicles from the video recordings;

FIG. 19 shows vehicle detection and interpretation by using machine learning;

FIG. 20 illustrates the vehicle path obtained directly from ML-spike ((a) of FIG. 20) or ML-curve ((b) of FIG. 20);

FIG. 21 is a schematic flowchart illustrating a method for monitoring a geological condition under a road with seismic data according to an example embodiment of the present disclosure;

FIG. 22 shows reference Green's function between station (seismic sensor) pair;

FIG. 23 shows Green's function comparison between reference time and target time;

FIG. 24 shows the image of relative change of seismic velocity under the road;

FIG. 25 is a schematic flowchart illustrating a method for monitoring a road surface condition with seismic data according to an example embodiment of the present disclosure;

FIG. 26 shows the change of road surface signature response over time;

FIG. 27 is a schematic flowchart illustrating a method for predicting traffic accident according to an example embodiment of the present disclosure; and

FIG. 28 shows an electronic device according to an example embodiment of the present disclosure.

### DETAILED DESCRIPTION

Hereinafter, various example embodiments of the present disclosure will be described with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

The example embodiments and the terms used therein are not intended to limit the technology disclosed herein to specific forms, and should be understood to include various modifications, equivalents, and/or alternatives to the corresponding embodiments. In describing the drawings, similar reference numerals may be used to designate similar constituent elements. A singular expression may include a plural expression unless they are definitely different in a context.

Also, the various embodiments described herein are not necessarily mutually exclusive, as some embodiments can be combined with one or more other embodiments to form new embodiments.

As used herein, singular forms may include plural forms as well unless the context clearly indicates otherwise. The expression “a first”, “a second”, “the first”, or “the second” used in various embodiments of the present disclosure may modify various components regardless of the order and/or the importance but does not limit the corresponding components. When an element (e.g., first element) is referred to as being “(functionally or communicatively) connected,” or “directly coupled” to another element (second element), the element may be connected directly to another element or connected to another element through yet another element (e.g., third element).

The expression “configured to” as used in various embodiments of the present disclosure may be interchangeably used with, for example, “suitable for”, “having the capacity to”, “designed to”, “adapted to”, “made to”, or “capable of” in terms of hardware or software, according to circumstances. In some situations, the expression “device configured to” may refer, for example, to a situation in which the device, together with other devices or components, “is able to”. For example, the phrase “processor adapted (or configured) to perform A, B, and C” may refer, for example, and without limitation, to a dedicated processor (e.g., embedded processor) for performing the corresponding operations or a generic-purpose processor (e.g., Central Processing Unit (CPU) or Application Processor (AP)) that can perform the corresponding operations by executing one or more software programs stored in a memory device.

Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units, engines, manager, modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

When using expressions such as “at least one of A, B, and C, etc.”, it should generally be interpreted according to the meaning that those skilled in the art usually understand (for example, “a system including at least one of A, B, and C” should include but not be limited to a system including A, B, C, A and B, A and C, B and C, and/or A, B, C, etc.).

In earthquake monitoring, seismic sensors are installed to record elastic waves propagating from an earthquake source. They are typically designed to monitor a large area on the earth and sensor locations may be irregular due to the constraint of installation sites. Each sensor records ground vibrations in a time series with a uniform sampling interval, and signals may be recorded in the form of displacement, velocity (velocity sensors) or acceleration (accelerometers) of the ground vibration. Through numerical computation, these three forms of data are approximately exchangeable. A seismic sensor is designed to record ground vibration for a specific frequency range subject to the limit of hardware and electronics. The recordings can be used to infer the earthquake source location, magnitude, source focal mechanisms, and the medium velocities between sources and receivers. The sensors may include a single vertical component recording vertical ground vibrations or three components recording ground vibrations along three orthogonal directions. A single three-component sensor is able to tell the direction of incoming seismic P or S waves with simplified assumptions.

The seismic studies are not limited to earthquake problems, but also widely applied for helping find oil and gas and other resources in the subsurface.

In seismic exploration for minerals, coals, or oil and gas, a seismic survey utilizes one or more controlled sources and one or more receivers to collect information about phase and amplitude of seismic waves. The sources and receivers used in a seismic survey can be placed on the earth's surface regularly or irregularly following designed geometry along a line for two-dimensional imaging or in an area for three-dimensional imaging. In these surveys, the sources and receivers are set at known locations. The velocity medium or rock interfaces are the target to image.

Seismic data may include a large number of seismic traces. Each sensor records a trace with a vertical component or three traces with three components. Seismic traces include data of ground movement over a period of time and they are recorded at receivers, which can be geophones, hydrophones, Micro-Electro-Mechanical Systems (MEMS) sensors, Distributed Acoustic Sensing (DAS) or other seismic monitoring equipment. Receivers may be deployed at approximately constant intervals along the surface. While passive collection of ground movement may be performed, a seismic survey may use sources to create seismic waves from a known origin. A source is the location where a seismic wave originates. A shot is a release of energy at a source to create seismic waves, such as a single blast of dynamite or vibrator. The location where the shot occurs is called a source. A shot may be performed at a source to create seismic waves. Multiple shots may be performed at different sources and times.

Seismometers are installed in ground to record vibrations due to earthquakes or controlled sources. The data can be analyzed to reveal the information of sources or the earth media in which seismic waves propagate through. The seismic sensors can be also installed along roadside to monitor ground motion due to passing vehicles as passive sources. Analyses of the data with designed algorithms and methods can help reveal the speed, the weight, the spacing, the location, and driving pattern of all vehicles along the entire road monitored by seismic sensors. The data can be also used to monitor daily changes of the road or bridge conditions for risk assessment. The results can help minimize accidents or disasters, and help facilitate traffic control and safe driving with small cost.

A design of traffic flow reconstruction processing using seismic data may include one or more of the following steps:
(1) Receiving traffic vibration data recorded onsite and transferred in real-time on a computer;
(2) Data signal enhancement via digital processing;
(3) Two-way traffic wavefield separation or attenuation;
(4) Surface-consistent amplitude corrections;
(5) Extracting amplitude and frequency attributes for vehicle weight and type;
(6) Scanning vehicle speed to generate speed spectrum;
(7) Using ML methods to detect vehicles and output vehicle labels on time traces with spikes or Gaussian signals at vehicle arrival time;
(8) Associating spikes or Gaussian signals from (7) to create vehicle moving curves with time and position along the recording line;
(9) Inferring driving behavior from vehicle curves and lane positions; and
(10) reconstructing real-time traffic flow that includes vehicle type, weight, speed, and position (location and lane).

An embodiment of this application provides a method for monitoring traffic flow with seismic data, thereby reducing system layout costs, reducing an amount of data to be processed, protecting personal privacy, and high timeliness. The method may comprise: obtaining, from seismic recording devices, the seismic data; obtaining a seismic data fluctuation graph based on the seismic data, wherein the seismic data fluctuation graph comprises a plurality of seismic data fluctuation curves for each of the seismic recording devices; and monitoring the traffic flow based on the seismic data fluctuation graph.

Extracting the information of the speed, the weight, number of axles, the location, the lane position, and driving pattern of all vehicles from ground vibration data is relatively simple, and the data size is several orders smaller than video data. The results of vibration data analyses could offer a global view of all vehicles on the roads or in a city and help the use of camera systems to focus on certain vehicles or certain roads with minimum cost and computational efforts. The camera systems are like human's “eyes,” while the listening capabilities are like human's “ears.” The combination of “eyes” and “ears” enables a monitoring capability for many applications more robust.

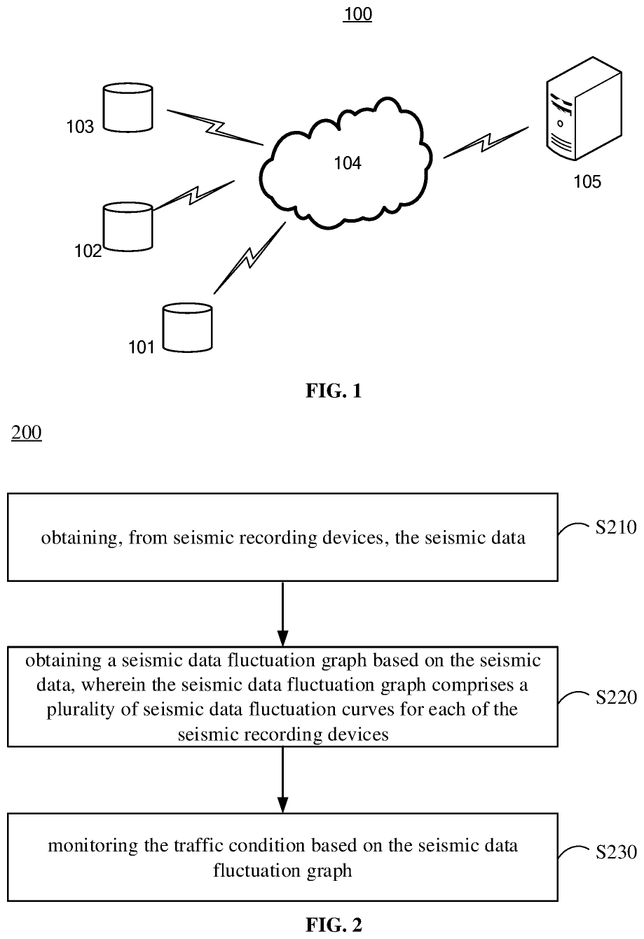

Referring now to the drawings, and more particularly to FIGS. 1 through 28, where similar reference characters denote corresponding features consistently throughout the figures, there are shown preferred embodiments.

FIG. 1 is a schematic diagram of a system architecture for performing a traffic and road monitoring method according to an example embodiment of the present disclosure.

It should be noted that FIG. 1 is only an example of an architecture of the system that may apply the embodiments disclosed in this application to assist those skilled in the art in understanding the technical contents disclosed herein, but it does not mean that the disclosed embodiments cannot be used for other devices, systems, environments, or scenarios.

As shown in FIG. 1, the system architecture 100 according to the embodiment may include seismic recording devices, such as, seismic sensors, 101, 102, 103, network 104, and server 105. Network 104 is a medium used to provide communication links between seismic sensors 101, 102, 103, and server 105. Network 104 can include various types of connections, such as wired, wireless communication links, or fiber optic cables, and so on.

In an embodiment, the seismic data may be transferred via 5G/4G cellular network or Wi-Fi or fiber optic internet cable.

Server 105 can be a server that provides various services. Server 105 can be a cloud server, also known as a cloud computing server or cloud host. Server 105 can also be a server for distributed systems or a server that combines blockchain technology.

It should be noted that the traffic and road monitoring methods in the embodiment can generally be performed by server 105. Correspondingly, the units or modules for performing the method in the embodiment can be provided in the server 105. The traffic and road monitoring methods according to the embodiments can also be executed by devices, servers or server clusters that are different from the server 105 and can communicate with the server 105. Correspondingly, the units or modules for performing traffic and road monitoring methods according to the embodiments can also be set in devices, servers or server clusters that are different from server 105 and can communicate with the server 105.

### Traffic Monitoring

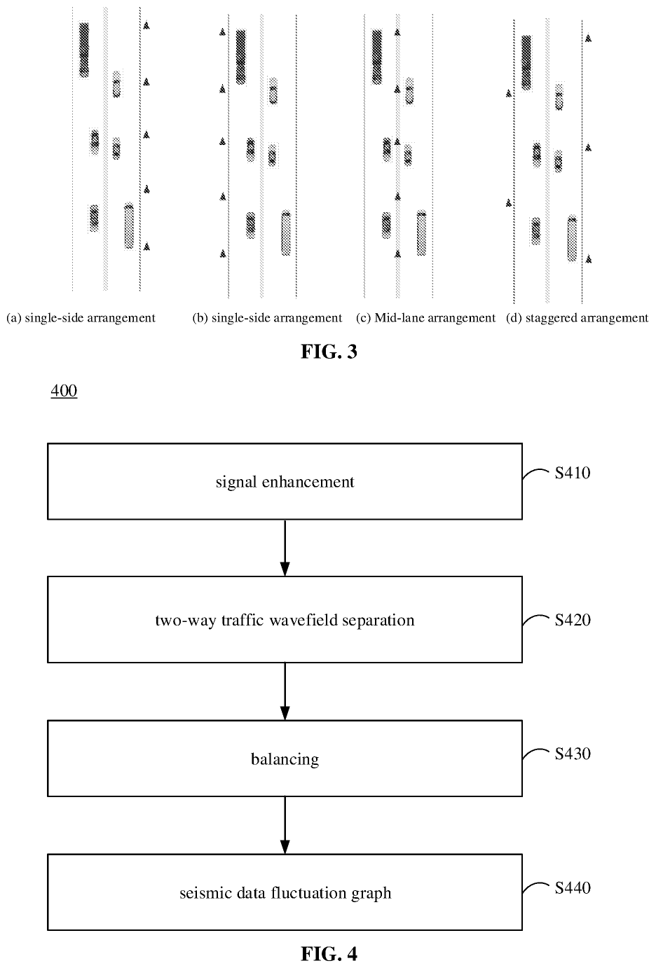

FIG. 2 is a schematic flowchart 200 illustrating a method for monitoring traffic flow according to an example embodiment of the present disclosure.

As shown in the FIG. 2, the flowchart 200 may comprise the following operations.

In operation S210, seismic data may be obtained from the seismic recording devices. In an embodiment, the seismic recording devices may be geophone, or seismic sensor, or ground vibration recording device.

In an embodiment, the seismic recording devices are arranged at a fixed or variable interval on one side of a road, on both sides of the road, or in the middle of the road or any combination thereof. This will be described by referring to the FIG. 3.

The seismic vibration generated from the moving vehicle along the roadside is recorded via seismic sensors. The recorded seismic data is used for reconstructing traffic flow, and estimating of moving vehicle information in real-time.

Frequency Range of Vehicle Vibration Data—Seismic sensors record vibration data within a frequency range, from 0.01 Hz to several thousand Hz. Across the entire frequency spectrum of the recorded data, the frequency response of a larger and heavier vehicle differs from that of a smaller and lighter vehicle. Therefore, capturing the complete frequency range of ground vibrations induced by vehicles becomes imperative. Furthermore, using the full frequency range of recorded vehicle vibrations is crucial for determining the road surface condition and sub-road structures.

In operation S220, a seismic data fluctuation graph may be obtained based on the seismic data, wherein the seismic data fluctuation graph comprises a plurality of seismic data fluctuation curves for each of the seismic recording devices.

The details about the operation S220 will be described in detail with reference to FIGS. 4 to 6.

In operation S230, the traffic flow may be monitored based on the seismic data fluctuation graph.

Monitoring the traffic flow may comprise digital traffic flow reconstruction and detecting anomaly activities.

FIG. 3 shows a schematic diagram of several example designs of recording positions of seismic sensors along a road for monitoring traffic.

As shown in the FIG. 3, the example arrangements of the seismic sensors may comprise: single-side arrangement (such as, on the right side of the road as shown in (a) in the FIG. 3, on the left side of the road as shown in (b) in the FIG. 3); mid-lane arrangement (such as, in the center island, or dividing zone as shown in (c) in the FIG. 3); both-sides arrangement, such as on both side of the road in a staggered way as shown in (d) in the FIG. 3, and any combination thereof.

FIG. 4 shows a schematic flowchart 400 of processing the seismic data.

As shown in the FIG. 4, the flowchart 400 may comprise the following operations.

In operation S410, a signal enhancement on the seismic data may be performed.

Vehicle Signal Enhancement-seismic sensors record vehicle signals and also noise within the same and/or different frequency band, therefore, denoise or enhancing signals are needed. This may include applying machine learning (ML), bandpass filtering, median filtering, RMS filtering, automatic gain control (AGC), trace balancing, wavelet transformation, stacking signals within a moving time window, extracting signal envelops, transforming data using STA/LTA ratio (short and long window ratio), and convolution with a wavelet.

The signal enhancement may comprise one or more of the following:
(1) Removing or attenuating noise;
(2) Remove or attenuating irregular signal from non-vehicle vibration;
(3) Removing or attenuating secondary response of the initial vehicle vibrations;
(4) Applying mathematical Log operation on traffic data to normalize amplitudes;
(5) Taking arbitrary exponent (including square root) on traffic data to normalize amplitudes;
(6) Applying automatic gain control (AGC) on traffic data to normalize amplitudes;
(7) Applying root mean square (RMS) of traffic data to normalize amplitudes;
(8) Applying median filtering on traffic data to smooth data and remove outlier;
(9) Applying mean filtering on traffic data to smooth data;
(10) Applying integration filtering on traffic data to amplify weak signals;
(11) Applying global normalization on traffic data;
(12) Applying single station (sensor) normalization on traffic data;
(13) Applying local window normalization on traffic data;
(14) Applying (4)-(13) above on signal envelopes of the traffic data;
(15) Applying bandpass filtering on traffic data or processed data;
(16) Applying Linear Moveout Corrections (LMO) to data with a preset vehicle speed relative to a recording station;
(17) Applying any combination or partial combination of (1)-(16).

In operation S420, a two-way traffic wavefield separation or attenuation can be performed after the signal enhancement.

The two-way traffic wavefield separation or attenuation may comprise:
Frequency-wavenumber domain filtering (FK filter);
FK filtering on the preprocessed seismic data;
Applying attenuation on preprocessed seismic data;
Applying machine learning (ML)by inputting two-way traffic data and outputting one-way traffic data.

In operation S430, a balancing seismic data may be performed by using a correction curve.

Balancing seismic data between recording stations provided with the seismic sensor may comprise:
1) Applying surface-consistent amplitude correction on traffic data;
2) Applying seismic trace normalization on traffic data.

Surface-Consistent Amplitude Correction—For the same vehicle passing through different roadside receivers at the same speed, the amplitude response may vary due to the variations of road structures and receiver ground coupling. Such amplitude amplification or reduction effects are associated with a particular site and receiver, all vehicles passing through the same site are subject to the same effects. Therefore, it is surface consistent. The amplitude variations can be measured from an existing dataset and a response curve can be interpolated for correcting the amplitude variations. To account for responses due to different weight of vehicles, multiple correction curves may be produced according to different weight groups of vehicles.

Due to the road and sub-road condition difference between each station, the recorded seismic data from the vehicle vibration needs to be corrected.

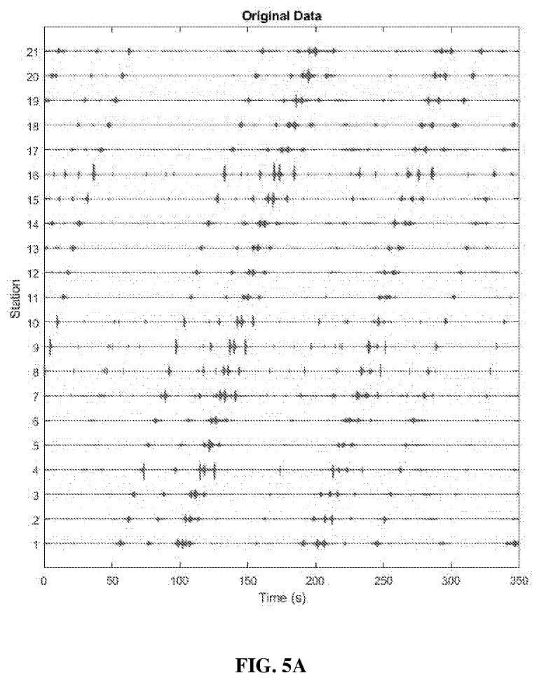

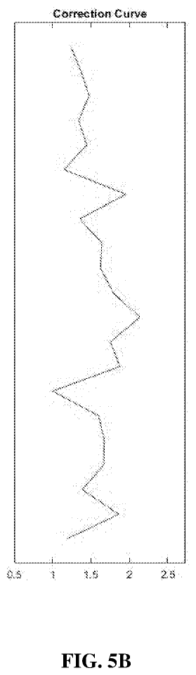

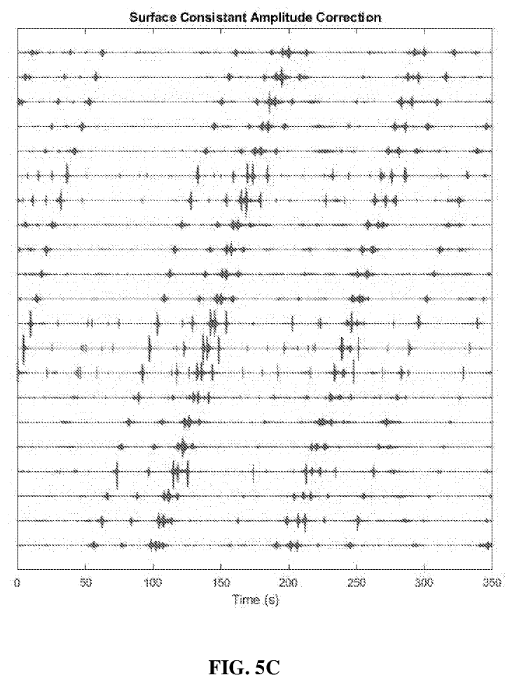

FIG. 5A-5C show such correction process by multiplying the original recorded data with the site correction function/correction curve to get seismic amplitude corrected data for further processing. The vertical axis represents the spatial location of the seismic sensors. The horizontal axis on the seismic data plots (FIG. 5A and FIG. 5C) denotes the recording time, while the horizontal axis of FIG. 5B represents the site correction value.

FIG. 5A shows original data, FIG. 5B shows a correction curve, and FIG. 5C shows a diagram after the surface-consistent amplitude correction.

In operation S440, a seismic data fluctuation graph may be obtained based on the balanced seismic data.

To eliminate some background noise and highlight vehicle events, bandpass filtering on various frequency range is needed. In an embodiment, after balancing seismic data, a bandpass signal processing may be performed.

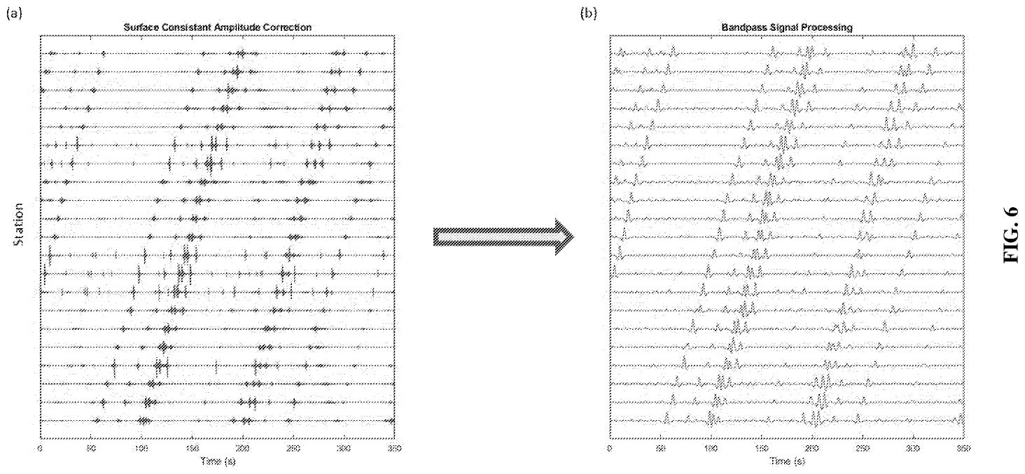

FIG. 6 shows the bandpass filtering applied on the amplitude corrected data.

(a) in FIG. 6 shows a diagram for the surface-consistent amplitude correction, and (b) in FIG. 6 shows a diagram for the bandpass signal processing.

It can be seen that after the bandpass signal processing, the seismic data fluctuation graph becomes clearer.

In an embodiment, the seismic data fluctuation graph may be obtained based on the bandpass signal processed seismic data.

In an embodiment, a vehicle speed spectrum may be obtained based on the seismic data fluctuation graph, wherein the vehicle speed spectrum is used to visually display a motion status of a vehicle.

Vehicle Speed Spectrum—a two-dimensional image plot in (time, speed) or (speed, distance) with image points corresponding to moving vehicles, and the amplitude of any image point is associated with the weight of the vehicle. To generate vehicle speed spectrum, we iterate through all receivers (where a seismic trace is recorded) and traverse a time window within the trace. For each seismic trace recorded at a receiver over a time window, one selects multiple traces of adjacent receivers on one side of the current receiver, and multiple traces of adjacent receivers on the other side of the current receiver. For each chosen receiver (where a trace is recorded) on both sides of the current receiver, a Linear-Moveout (LMO) correction is applied, in which the correction time is computed by dividing the distance offset between the two receivers by a specified vehicle speed. Subtracting the calculated correction time from all the corresponding traces, we can then stack all the traces after corrections, and produce a single trace associated with the specified vehicle speed. Loop over all the speeds within the specified vehicle speed scanning range and repeat the above process; this produces a spectrum in (time, speed) associated with the current receiver. The above process is conducted for a small-time window around t for each receiver, and the rotated speed spectrum (speed, time) is placed at the corresponding receiver location. Combining the speed spectrum for all receivers at time t in the domain creates final speed spectrum along the road (speed, distance).

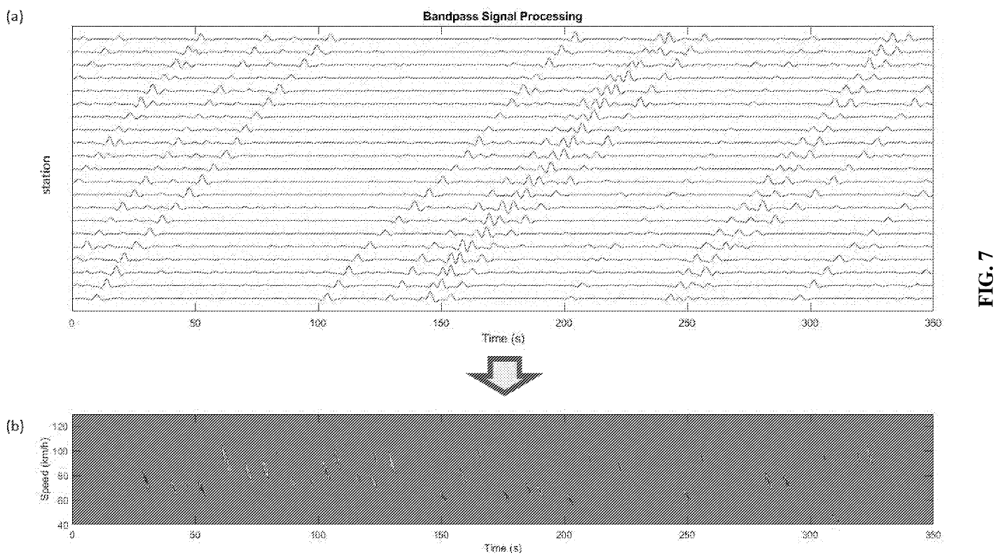

FIG. 7 shows the vehicle speed spectrum generated from bandpass signal processed data.

To obtain the vehicle speed spectrum, linear moveout (LMO) stacking and speed scanning on the preprocessed data are needed. (a) in FIG. 7 shows the bandpass signal processed data used for LMO stacking. (b) in FIG. 7 shows the vehicle speed spectrum in time domain for the station location plotted with the signal. The vertical axis of the speed spectrum is the vehicle speed. Each individual bright spot (cloud) in the speed spectrum indicates an individual vehicle.

Generating vehicle speed spectrum from signal enhanced traffic data may comprise:
(1) Scanning a range of vehicle speed;
(2) Applying linear moveout stacking for given scanning speed;
(3) Creating vehicle speed spectrum image in time domain.

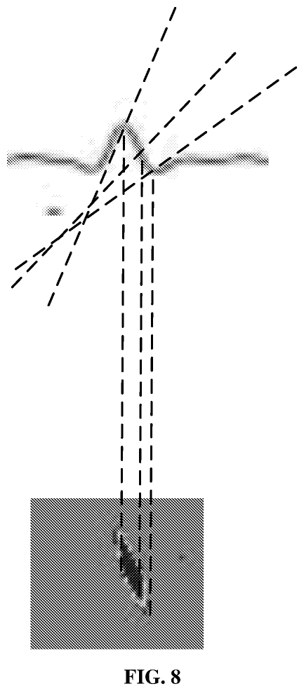

FIG. 8 shows a diagram for generating vehicle speed spectrum from signal enhanced traffic data.

As shown in FIG. 8, the seismic data fluctuation curve is scanned by a virtual scanning line. Intersection points of the virtual scanning lines and the seismic data fluctuation curve are mapped to points in the vehicle speed spectrum.

In an embodiment, a vehicle speed and/or a vehicle moving path for the vehicle may be determined based on the similarity between seismic data from different seismic recording devices.

In an embodiment, the similarity between seismic data from different seismic recording devices may include similarity between peaks and/or velocities, and so on.

Vehicle Association—associate vehicle image spots on different Vehicle Speed Spectrums to reveal the same vehicle movement and derive a speed curve over time or over distance for each vehicle. This is done by applying the function of Predicting Next Vehicle Location to connect all image spots or by applying a machine learning method to track the same image spot on different Vehicle Speed Spectrums. To precisely associate (or match) the vehicles detected from the Vehicle Speed Spectrums, the Hungarian method can be utilized to identify the optimal match, thereby creating the vehicle speed curve over time or distance. Instead of deriving the vehicle speed curve from the vehicle speed spectrum, it is possible to directly generate the vehicle speed curve from the recorded seismic data by utilizing a machine learning method.

Hungarian Algorithm—is a combinatorial optimization algorithm that solves the assignment problem in polynomial time. The algorithm is often used for solving the linear assignment problem, where the goal is to find the optimal pairing of elements from two sets, subject to certain costs or weights associated with each pair. For vehicle detection and association using traffic data, the Hungarian algorithm may be employed to associate detected vehicles over time and/or stations, optimizing the overall assignment of tracks to vehicles in a way that minimizes a certain cost function, which may include factors such as the speed and amplitude differences among vehicles.

In an embodiment, determining of the vehicle speed and/or vehicle moving path using geophysical method may comprise:
Utilizing the time domain vehicle speed spectrum at neighboring stations;
Finding the association of the same vehicle;
Connecting the same vehicle by line, comprising:
   Using piecewise linear line;
   Using piecewise polynomial curve;
   Using piecewise polynomial curve, smooth at the recording station.

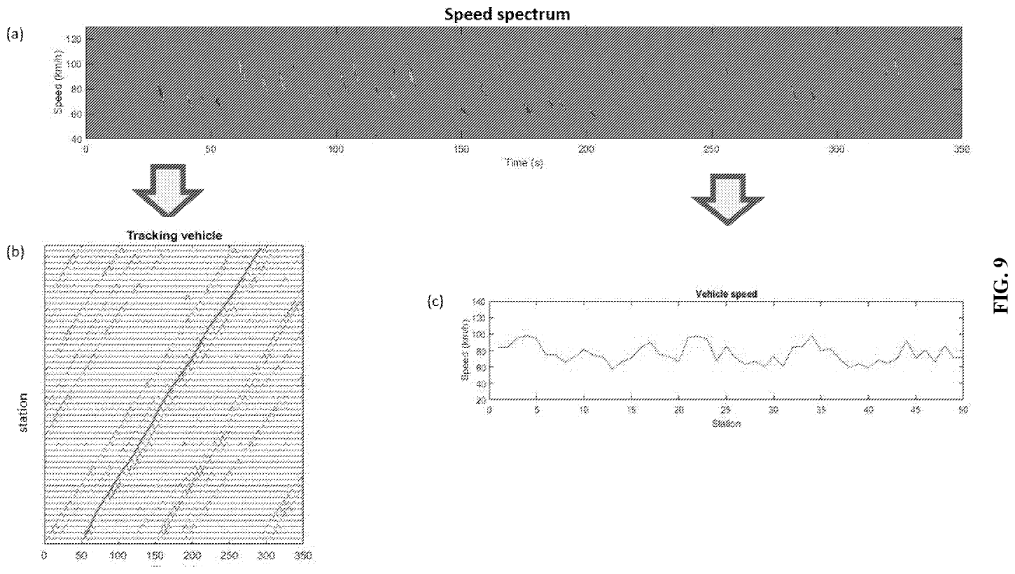

FIG. 9 shows the vehicle path and the extraction of vehicle speed from the speed spectrum.

To obtain the speed and moving path for each individual vehicle, it is necessary to associate the bright spots (clouds) between the station.

As shown in (b) of FIG. 9, an upward-sloping curve formed by connecting multiple points at different stations represents the vehicle path. The vehicle speed at a certain point of the upward-sloping curve may be determined based on the slope at that point. Because the upward-sloping curve is not a straight line, the vehicle speed varies between different stations.

According to the slopes at different points, a vehicle speed curve for the vehicle can be shown in (c) of FIG. 9.

The individual vehicle moving path and speed information can then be used to determine the irregular driving, traffic violation, and provide traffic accident warning.

In an embodiment, determining of the vehicle's speed from the vehicle speed spectrum and the moving path may comprise:
Using the vehicle speed from the speed spectrum at the recording station;
Interpolating the speed for the same vehicle between the recording station; and
Making the derivative on individual vehicle moving curve obtained by using piecewise polynomial curve and/or by using piecewise polynomial curve, and smooth at the recording station.

In an embodiment, it may be determined whether the vehicle is overspeed based on the vehicle speed.

In an embodiment, a reference line may be used to determine whether the vehicle is overspeed.

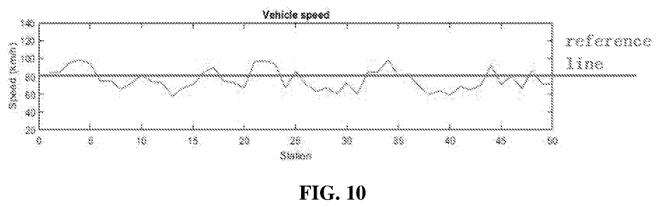

FIG. 10 shows a diagram used to determine whether the vehicle is overspeed. Specifically, when the vehicle speed curve is above the reference line, the vehicle is overspeed, and when the vehicle speed curve is below the reference line, the vehicle is not overspeed.

In an embodiment, a type and a weight of a vehicle may be determined based on a peak for the vehicle in each of plurality of seismic data fluctuation curves.

Vehicle Weight—Amplitude response associated with a vehicle in the seismic recording is due to the weight, the speed, and the axels of the vehicle, road conditions, soil conditions underneath the road, sensor instrument response, and sensor coupling with the ground. The weight of the vehicle plays a dominant role in the amplitude of signals. With other factors calibrated or isolated, the vehicle weight can be estimated from the amplitude response.

In an embodiment, the determining of relative vehicle weight and vehicle type via extracting vehicle amplitude and frequency attributes, including data envelope and power spectrum, may comprise:
Determining vehicle type from vibration signals;
Determining vehicle weight from seismic amplitude and phase, vehicle speed, number of axels, data envelope, and power spectrum;
Creating linear regression empirical relationship between vehicle weight, lane position, number of axels, and seismic response of the vehicle over recording stations; and
Creating nonlinear regression empirical relationship between vehicle weight, lane position, number of axels, and seismic response of the vehicle over recording stations.

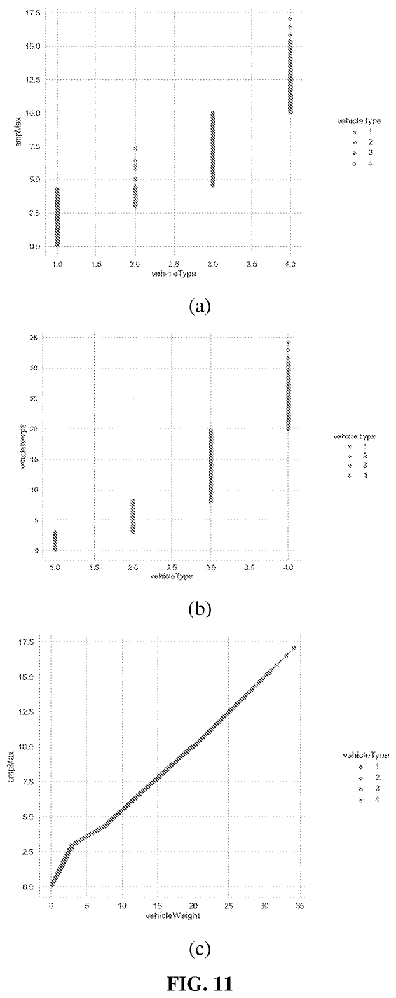

FIG. 11 shows interpretation of vehicle type, speed and weight in relationship with seismic amplitude.
(a) in FIG. 11 shows the interpretation of vehicle type from seismic amplitude.
(b) in FIG. 11 shows the relationship of vehicle type and vehicle weight.
(c) in FIG. 11 shows the relationship of vehicle weight and seismic amplitude from linear regression.

In an embodiment, four types of vehicles (small, medium, medium-large and large) are considered.

It can be seen that the larger the vehicle size, the heavier the weight, and the greater the amplitude.

Because the recorded seismic data generated by vehicles contains the information of vehicle speed, weight, type, and driving lane, ML can be used for extracting these vehicles information. This disclosure introduces an intermediary step in ML to improve the detection of vehicles by transforming the seismic time series data into a heat map of the road which produces real-time information of the road condition. This information can then be used to detect vehicles and determine its location, driving lane, moving path, speed and even type and weight.

In an embodiment, the determination of the vehicle type, speed and weight may be performed using a vehicle type, speed and weight recognition model.

In an embodiment, the vehicle type, speed and weight recognition model may be trained using a plurality of known vehicle types, speeds and weights along with corresponding seismic data.

In an embodiment, the vehicle type, speed and weight may be determined by inputting seismic data to the vehicle type, speed and weight recognition model.

Vehicles stopping on highway—Vehicles stopping on a highway can pose significant risks and challenges to both drivers and overall traffic flow. Sudden halts may occur due to emergencies, breakdowns, or unforeseen circumstances, creating potential hazards. When a vehicle comes to a stop on a busy highway, it disrupts the smooth flow of traffic and increases the likelihood of rear-end collisions. In such situations, a prompt response from traffic authorities is vital, and issuing warnings to approaching drivers becomes crucial. When a vehicle stops on a highway, the continuity of vehicle vibration signal along the road is interrupted in the recordings. Applying algorithms or machine learning methods to analyze data can help detect the sudden stops and inform the traffic control authority. Reconstruction of traffic flow in real-time using seismic data can provide early warning to law enforcement authority, and take the immediate action to avoid sudden stops on highways, thereby maintaining traffic safety and reducing the risk of dangerous collisions.

In an embodiment, it may be determined whether the vehicle is stopping based on the vehicle moving path.

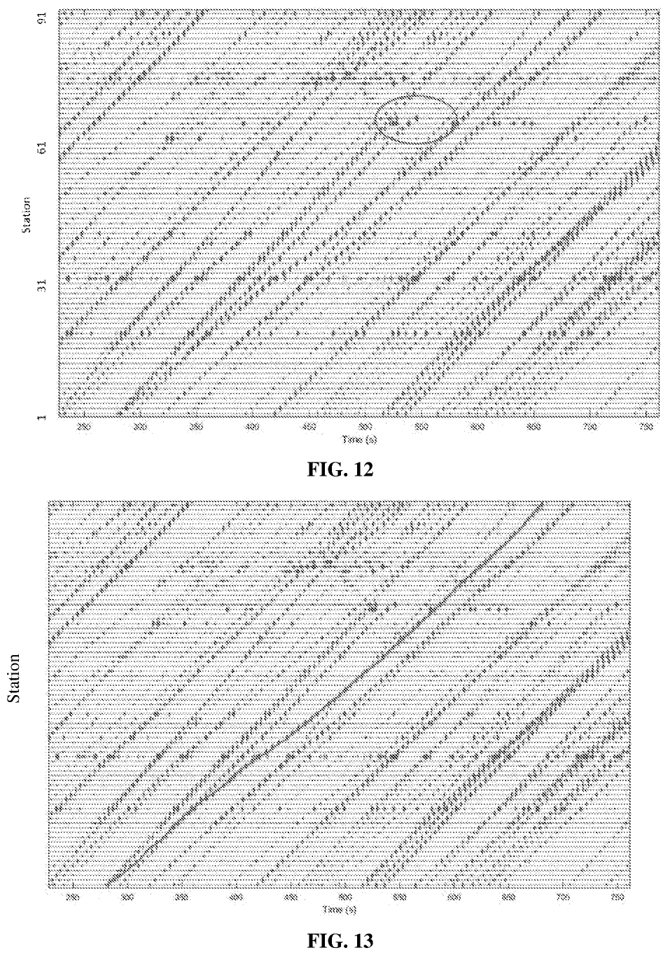

FIG. 12 shows a diagram illustrating vehicle stopping. It is obvious to see within the oval, the seismic data at the center of the oval disappears at the next sensor location. This indicates that the vehicle has a sudden stop.

FIG. 13 illustrates a single vehicle moving path (as indicated by the curve) along the road. The curve is tracked in the recorded seismic data of the vehicles. From this selected vehicle moving path, one can easily obtain the vehicle moving speed (the slope of the curve) and analyzing the behavior of the driver, either the driver is speeding or not.

Vehicle Trim Statics—a small time correction that adjusts signal phase variation of the same vehicle on a particular trace for high quality stacking in the speed spectrum calculation. The signal moveout across a few nearby traces should be close to be linear. Variations may be due to irregular receiver positions, lane change, and vehicle speed changes. Such trim statics can be calculated using stacked trace to correlate individual trace before stacking, or directly extracted from data using a machine learning method.

Vehicle Early-Warning System—With the information of traffic flow derived from data of seismic sensors, any rapid reduction of the entire traffic speed or some or individual vehicle speed revealed near a seismic sensor will automatically trigger warning for all incoming vehicles behind. Such warning could be displayed on electronic roadside message boards, or in the form of warning lights or alarm sounds, and on the monitoring screens of traffic authorities. The warning message could be delivered to nearby mobile phones or navigation systems in vehicles. The Vehicle Early-Warning System is designed to avoid or minimize traffic accidents, especially in foggy days or at blind turns on the road.

As shown in FIG. 13, the curve indicates a vehicle's moving path. From this moving path, one can determine the corresponding vehicle's speed. the speed is gradually decreased, which may indicate that there is traffic jam ahead.

In an embodiment, pedestrian walking on the road may be detected based on seismic data.

Walking on highways poses immense danger due to the high-speed traffic and lack of pedestrian-friendly infrastructure. It is an incredibly risky activity that increases the likelihood of accidents and injuries for both pedestrians and drivers. By analyzing seismic data recorded along the highway and using ML technologies, one can provide early warning of the incident, and prevent potentially fatal accidents. When a person walking by a seismic sensor, the walking steps will be recorded by the sensor and identified by real-time analyses.

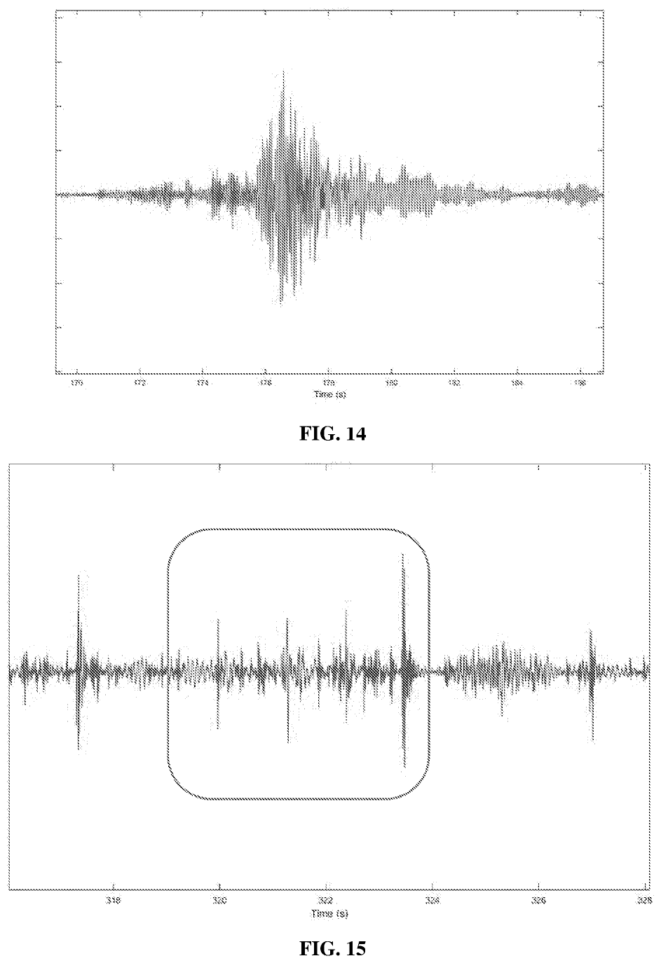

FIG. 14 shows a typical seismic response of a vehicle.

FIG. 15 gives the seismic response of people walking on the highway (as indicated within an area).

Based on the type of seismic signal, it may be determined whether a person is walking on the road or a vehicle is driving in the lane.

Falling objects from moving vehicles—Objects falling from moving vehicles can cause serious safety hazards on roads. Whether it is unsecured cargo, debris, or items accidentally dropped, these falling objects have the potential to cause accidents, property damage, or injuries. Quick detecting falling objects from a moving vehicle is crucial for preventing accidents and ensuring road safety. Utilizing seismic data recorded along the road and employing advanced geophysical techniques and machine learning algorithms, a real-time traffic monitoring system can enhance road safety by quickly detecting and notifying authorities of falling objects from moving vehicles, thereby reducing potential accidents.

Natural Hazard Intensity Map—earthquakes, storms, hurricanes, or typhoons will shake the ground. An intensity map of the ground vibrations can be revealed and reported in real-time using the same roadside seismic sensors. The map can be used by the authority and public for planning rescues and issuing warning.

Vibration-Triggered Video Attention—Information from seismic sensors can serve as supplementary to video surveillance. If any abnormal vibration is detected by seismic sensors, it can be used to trigger attention of video cameras near the same site. Such a trigger system can help avoid dealing with massive cameras and video data.

Just like detecting pedestrian, detecting of falling objects from moving vehicles, Natural Hazard Intensity Map and Vibration-Triggered Video Attention may be implemented.

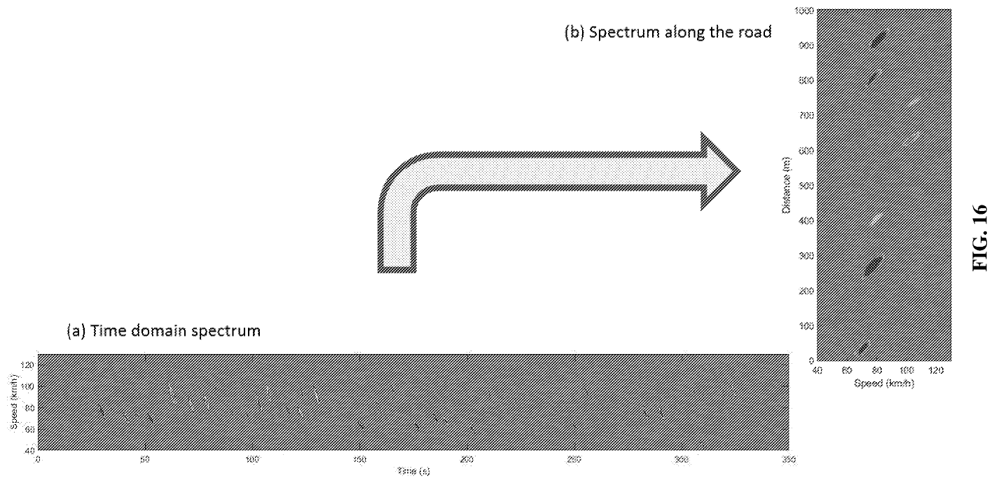

FIG. 16 shows the extrapolation of the speed spectrum in spatial domain. The vehicle speed spectrum along the road in spatial domain as shown in (b) of FIG. 16 is extrapolated from the vehicle speed spectrum in time domain as shown in (a) of FIG. 16. (b) of FIG. 16 visually illustrates the movement of vehicles along the road. This image as shown in (b) of FIG. 16 may provide a more intuitive and convenient view for traffic managers.

In order to get the vehicle speed spectrum along the road, the vehicle speed spectrum generated from LMO stacking in time domain for each station needs to be extrapolated along the road.

Generating vehicle speed spectrum along the road in space domain may comprise:
(1) Using the time domain vehicle speed spectrum at multiple recording station; and
(2) Extrapolating the speed spectrum in space domain along the road.

Predicting Next Vehicle Location—Based on the current Vehicle Speed Spectrum for a receiver over a time window (Time, Speed), one can predict the Vehicle Speed Spectrum at a virtual receiver close to the current one (forward or backward) by assuming that vehicle speed remains constant. Using the current Vehicle Speed Spectrum for a particular time across multple receivers (Speed, Distance), one can predict the Vehicle Speed Spectrum at the next time point close to the current one (forward or backward) by assuming that vehicle speed remains constant. Both of the above predictions are achieved by calculating a time or distance shift using speed values in the spectrum.

In (b) of FIG. 16, the vehicle speed spectrum for a particular time over a number of receivers along the road is depicted. From this, one can calculate vehicle's next location.

An embodiment according to the present application provides a system for monitoring traffic flow with seismic data.

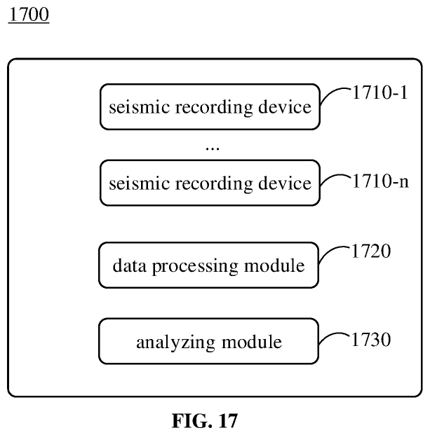

FIG. 17 is a structural diagram of a system 1700 for monitoring traffic flow with seismic data according to the embodiments.

As shown in FIG. 17, the system 1700 may comprise seismic recording devices 1710-1 to 1710-n, a data processing module 1720 and an analyzing module 1730.

In an embodiment, the seismic recording devices 1710-1 to 1710-n may be configured to obtain the seismic data.

In an embodiment, the data processing module 1720 may be configured to obtain a seismic data fluctuation graph based on the seismic data, wherein the seismic data fluctuation graph comprises a plurality of seismic data fluctuation curves for each of the seismic recording devices.

In an embodiment, the analyzing module 1730 may be configured to analyze the traffic flow based on the seismic data fluctuation graph.

In an embodiment, the analyzing module 1730 may be further configured to perform the above operations.

An embodiment according to the present application provides a method for training a vehicle recognition model, the method may comprise: obtaining a first image including a vehicle from a video; converting the first image into a second image, representing the vehicle and a lane in which the vehicle is driving, wherein the second image is used as a training label; obtaining a first seismic data corresponding to the first image from seismic data; and training the vehicle recognition model based on the first seismic data and the second image.

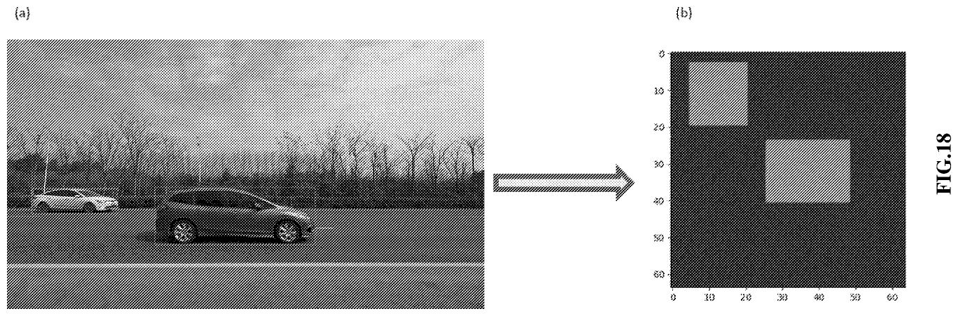

FIG. 18 shows conversion from a first video image into a second dual-color image, wherein (a) shows video recordings of the road and using image/video recognition techniques to detect vehicles, and (b) shows training labels generated by using the detected vehicles from the video recordings.

In an embodiment, vehicles in the first video image may be captured using YOLO algorithm.

YOLO Algorithm—is a real-time object detection system that can simultaneously identify, classify and locate multiple objects in an image or video frame. For vehicle detection and association through machine learning with traffic data, the YOLO algorithm can be utilized to generate labels by accurately capturing the ground truth of vehicles in motion on the road from recorded video.

The most important part of training the ML model is getting the label. We want to record a video of the road ((a) in FIG. 18) so we can get an absolute ground truth of the passing vehicles. In order to detect and capture vehicles in the video, the YOLO algorithm can be used on each frame of the video. This can then be turned into a bird-eye heat map ((b) in FIG. 18) of the road for simpler analysis.

In an embodiment, the YOLO algorithm may be used to detect and capture vehicles in the recorded video and transform the ground truth video recording into bird-eye view heatmap cartoon of the road for ML vehicle detection.

In an embodiment, the visual vehicle data may be used to generate ML training labels for the neural network, comprising:
(1) Generating labels from the intermediary step of detecting and capturing vehicles in the recorded video and transforming the ground truth video recording into bird-eye view heatmap cartoon of the road; and
(2) Getting the seismic data for the corresponding labels by dividing the seismic data into small window frame.

Using ML to generate heat map and detect vehicle information may include:
(1) Using any single component data from single-and/or multi-component sensors to generate heat map and detect vehicles, type, weight, speed, and lane;
(2) Using any combination of multicomponent data to generate road heat map and detect vehicles, type, weight, speed, and lane;
(3) Using multi seismic sensors to generate heat map and detect vehicles, type, weight, speed, and lane;
(4) Using any time series generated by vehicle to create heat map and detect vehicles, type, weight, speed, and lane; and
(5) Using any combination of above data to generate heat map and detect vehicles, type, weight, speed, and lane.

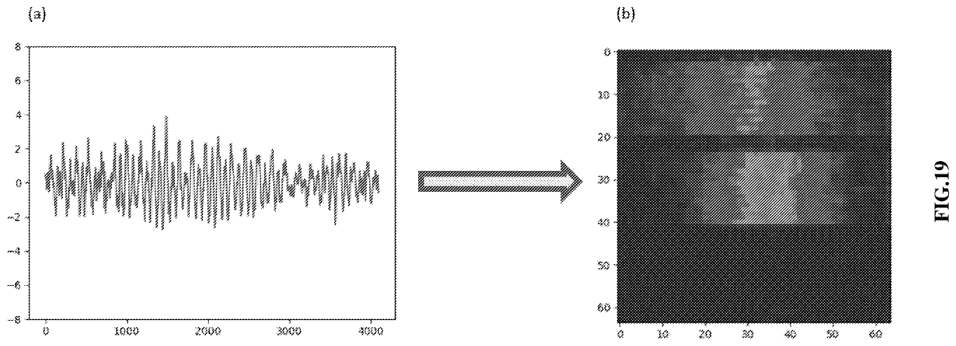

FIG. 19 shows vehicle detection and interpretation by using machine learning, wherein (a) shows seismic data graph for vehicle detection and interpretation, and (b) shows a generated heat map of the road that shows predicted vehicle locations.

To obtain the seismic data of the vehicle corresponding to the label, we divide the seismic data into small window frames (as shown in (a) of FIG. 19). After preprocessing of the seismic data, such as normalization, Fourier transformation, the data and label pair are then used to train a neural network that will be used to generate a cartoon-ized visual representation of the road (as depicted by (b) in FIG. 19). Furthermore, the visual representation of the road is use to analyze the locations the vehicles and obtain corresponding vehicle and road information.

An embodiment according to the present application provides a vehicle recognition method. The method may comprise: inputting seismic data to be identified into a vehicle recognition model to determine a vehicle and a lane on which the vehicle is driving, wherein the vehicle recognition model is trained using the method as described above.

An embodiment according to the present application provides a method for training a vehicle recognition model. The method may comprise: picking seismic data within a plurality of time windows, as labels; identifying a maximum peak or a Gaussian distribution peak of each of the labels; and determining a location of a vehicle corresponding to the maximum peak or the Gaussian distribution peak; and training the vehicle recognition model based on the location and the corresponding maximum peak or Gaussian distribution peak.

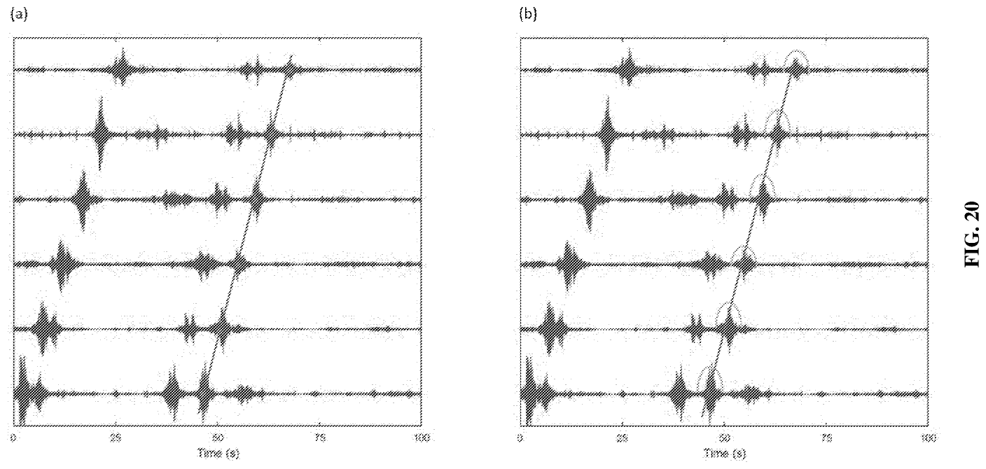

FIG. 20 illustrates the vehicle path obtained directly from ML-spike ((a) of FIG. 20) or ML-curve ((b) of FIG. 20).

Other than deriving the vehicle's trajectory solely from the vehicle speed spectrum, an alternative approach involves extracting the vehicle's trajectory directly from recorded vibration data, as depicted in FIG. 20. To obtain the vehicle's trajectory, it is crucial to generate ML-spike labels or ML-curve labels using the recorded vehicle vibration data. By training a neural network, an ML-spike model or ML-curve model is established, such models can then be employed in detecting the vehicle within the seismic data. In (a) of FIG. 20, the orange dot indicates the identified vehicle using the ML-spike model, while in (b) of FIG. 20, the orange curve represents the vehicle identified through the ML-curve model. Employing the Hungarian optimal match method facilitates the extraction of the vehicle's trajectory (depicted as the curve in both (a) and (b) of FIG. 20) based on the detected vehicle from either the ML-spike or ML-curve model.

In an embodiment, the vehicle detection and association using ML and Hungarian optimal matching algorithm on traffic data may comprise one or more of the following steps:
(1) Preprocessing the traffic data;
(2) Creating ML-spike labels (such as, peak) for the traffic data, where a vehicle signal corresponds to a spike at the same time on a recording trace;
(3) Training ML-spike model with the traffic data for input and spikes for labels;
(4) Creating ML Gaussian curve labels for the traffic data, where a vehicle signal corresponds to a Gaussian signal at the same time on a recording trace;
(5) Training ML Gaussian curve model with the traffic data for input and spikes for labels;
(6) Creating ML curve labels for user defined curve function on original or preprocessed data;
(7) Training ML curve model for user defined curve function on original or preprocessed data;
(8) Detecting ML spikes by running model from (3), and taking a small window of data around the corresponding spike in the traffic data or preprocessed traffic data;
(9) Detecting ML curves by running ML model from (5), and taking a small window of data around the corresponding peak of the ML-curves in the traffic data or preprocessed traffic data
(10) Detecting ML curves for user defined curve by running ML model from (7), and taking a small window of data around the corresponding peak of the ML-curves in the traffic data or preprocessed traffic data; and
(11) Applying Hungarian optimal matching to associate the detected vehicles from (8), or (9) or (10) between neighboring multiple stations to form the vehicle moving curve over these stations.

An embodiment according to the present application provides a vehicle recognition method. The method may comprise: inputting seismic data to be identified into a vehicle recognition model to determine a location of a vehicle; and determining a vehicle speed and/or a vehicle moving path of the vehicle based on the location, wherein the vehicle recognition model is trained using the method as described above.

The neural network can have additional metadata that includes information regarding the station. The metadata, such as temperature, road type, etc. can be used to improve vehicle detection results. Other domain adaptation methods and transfer learning techniques can be used as well to improve station to station results. Or if resources permit it, we can create a model for each given station.

The recorded vehicle vibration data can be used not only for traffic flow reconstruction, but also for monitoring the road and sub-road geophysical conditions, and obtaining the seismic velocity and structure images of the subsurface. The sub-road geophysical condition change can be used to provide the early warning of the potential hazard and prevent it happening.

### Road Monitoring

An embodiment according to the present application provides a method for monitoring a geological condition under a road with seismic data, the method may comprise: obtaining, from seismic recording devices, target seismic data and reference seismic data; generating a target Green's function based on the target seismic data; generating a reference Green's function based on the reference seismic data; generating a near-surface relative velocity change based on the target Green's function and the reference Green's function to monitor the geological condition under the road.

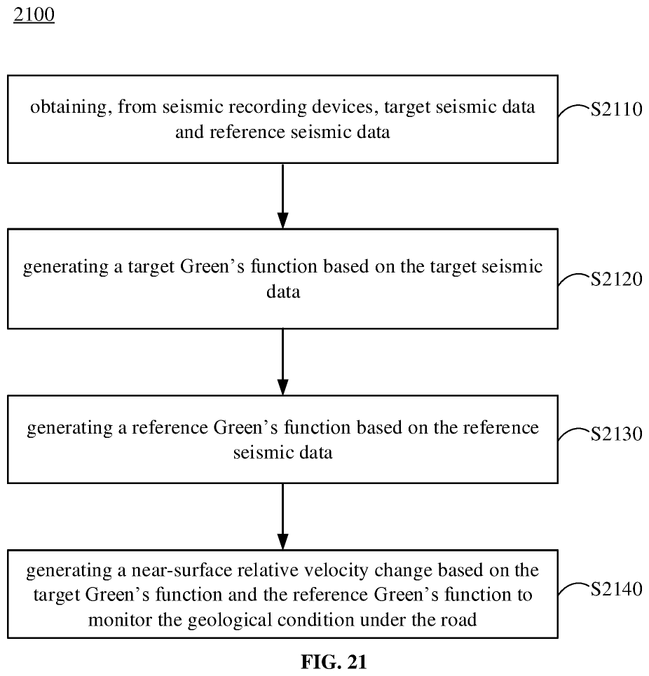

FIG. 21 is a schematic flowchart 2100 illustrating a method for monitoring a geological condition under a road with seismic data according to an example embodiment of the present disclosure.

As shown in FIG. 21, the flowchart 2100 may comprise the following operations.

In operation 2110, target seismic data and reference seismic data may be obtained from seismic recording devices.

In operation 2120, a target Green's function may be generated based on the target seismic data.

In operation 2130, a reference Green's function may be generated based on the reference seismic data.

In operation 2140, a near-surface relative velocity change may be generated based on the target Green's function and the reference Green's function to monitor the geological condition under the road.

In an embodiment, signal preprocessing, noise elimination, resampling, data shift correction and filtering may be performed on the target seismic data and the reference seismic data.

In an embodiment, the method for monitoring a geological condition under a road with seismic data may comprise one or more of the following:

(1) Preprocessing workflow of the traffic data, including:
Noise suppression.
Resampling.
Data drift correction.
Multi-frequency range (f₁ᵢ, f₂ᵢ) bandpass filtering, where f₀<f₁ᵢ<f₁;f₀<f₂ᵢ<f₁; f₀ and f₁ are the lower and upper limit of the sensor's frequency range.
OneBit filtering.
Median filtering.
RMS filtering.
Smoothing filtering.
Fourier transform of the traffic vibration data.
Conjugate of the Fourier transformed data.
Inverse Fourier transformation.
Inverse Fourier transformation of the conjugated Fourier transformed data.
Apply tapering on data in either time or frequency domain, or in both domains.

(2) From traffic data extract body wave, elastic P-wave, S-wave, SH-wave, surface wave, coda wave, Rayleigh wave and Love wave, and generate reference and target Green's function.

(3) Generating Green's function from the traffic data, comprising:
Using the data being preprocessed, as described in (1), or any combination of a) to (m) in (1);
Cross-correlation of preprocessed data between sensor pairs in time domain or frequency domain to generate reference Green's function;
Cross-correlation of preprocessed data between sensor pairs in time domain or frequency domain to generate target Green's function (or current time Green's function);
Stacking of the cross-correlated result from (b) and (c) in (3);
Weighted stacking of the cross-correlated result from (b) and (c) in (3).

(4) Using ambient noise imaging methods, reference and target Green's functions to create near-surface relative velocity change.

Ambient Noise Imaging—seismic sensors installed at the roadside can record vehicle movement and also ambient noise. Particularly after the midnight when the traffic stops, ambient noise can be well recorded and used to infer surface wave responses between any two receivers. Correlating the Green's functions or coda waves over a time interval produces velocity changes in the near surface area and helps image the changes of road conditions.

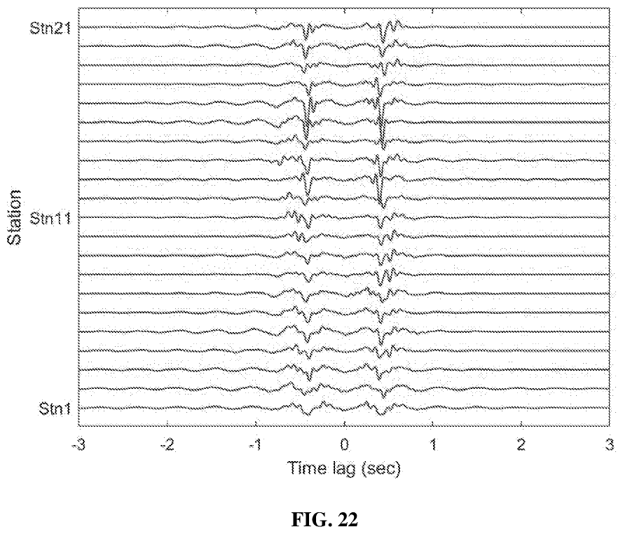

FIG. 22 shows reference Green's function between station (seismic sensor) pair.

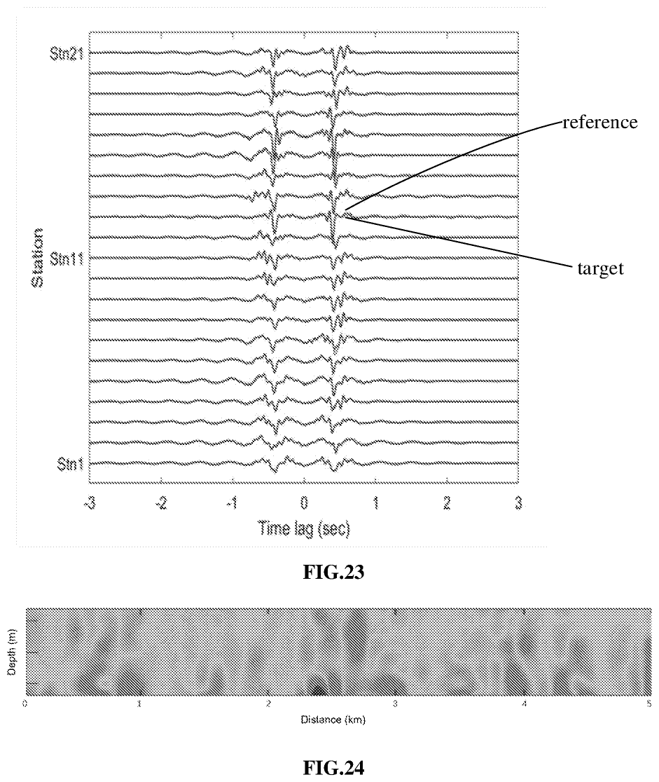

FIG. 23 shows Green's function comparison between reference time and target time.

FIG. 24 shows the image of relative change of seismic velocity under the road.

According to FIG. 24, the geological changes below the road can be observed.

In addition to reconstructing the real-time traffic flow and monitoring the sub-road geophysical condition, the recorded seismic data from the vibration of the vehicle can also be used for monitoring the road surface signature response change over time. Analyzing the road surface signature response, one can comprehend and predict its future change, and provide early warning of the road condition in real-time, therefore, authorities can implement maintenance strategies and construction techniques that enhance road safety and longevity, ultimately benefiting all road users.

Road Surface Signature Response—referring to the dynamic behavior of a road under various conditions, including its interaction with environmental factors, traffic loads, and the overall ability to withstand stress. Because road surfaces are constantly reacting to vehicle loads and are affected by environmental changes, temperature fluctuations and extreme weather conditions (rain and snow), it is important to understand how roads degrade, wear or become stressed over time. Seismic data recorded along the road can be used for real-time monitoring of the road surface conditions and assessing the health of the road. Through real-time monitoring of the road and analyzing of the seismic data in time and/or frequency domain, road service organization can plan maintenance schedules timely to ensure safe and durable infrastructure for travelers.

Falling rock and landslide—Falling rocks and landslides on roads present a constant challenge for safe transportation, particularly in mountainous or geologically unstable regions. These events, whether sudden rockfalls or gradual landslides, pose grave risks, potentially causing vehicular damage, injuries, or road blockages. Seismic sensor installed along the roadside and analyzing the collected seismic data can provide real-time monitoring and warning of the occurrence, and help manage these hazards, ensuring safe passage and minimizing the impact of falling rocks and landslides on road travelers.

Avalanche—During winter season in the mountain area of the north, avalanche could pose a hazard that swiftly block road, leading to isolation, accidents, or even fatalities. Roadside infrastructure designed using seismic sensor can continuously monitor the road. Analyzing seismic data collected from seismic sensor is vital for minimizing the dangers posed by avalanches and ensuring safer passage for all.

An embodiment according to the present application provides a method for monitoring a road surface condition with seismic data, the method may comprise: obtaining, from seismic recording devices, target seismic data and reference seismic data; calculating, based on the reference seismic data, a first total energy of passing vehicles within a first frequency range at a reference time; calculating, based on the target seismic data, a second total energy of passing vehicles within a first frequency range at a target time; and monitoring the road surface condition based on the first total energy and the second total energy.

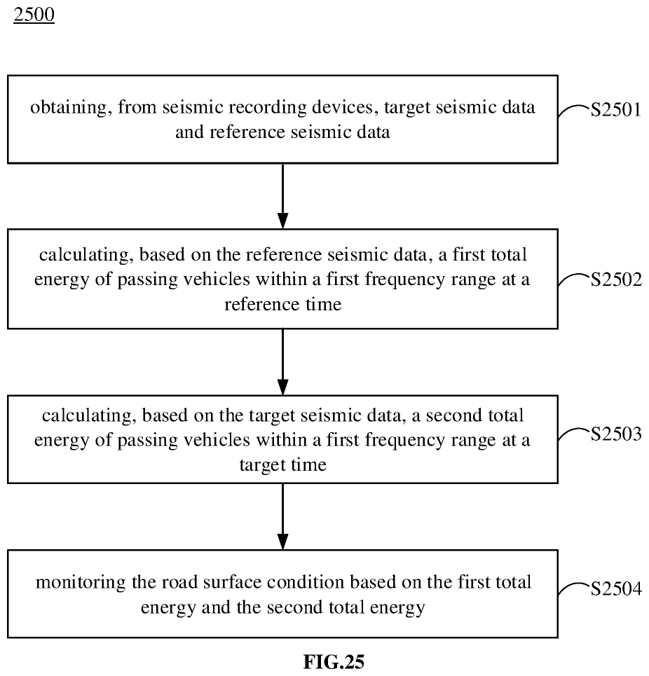

FIG. 25 is a schematic flowchart illustrating a method for monitoring a road surface condition with seismic data according to an example embodiment of the present disclosure.

As shown in FIG. 25, the flowchart 2500 may comprise the following operations.

In operation 2501, target seismic data and reference seismic data may be obtained from seismic recording devices.

In operation 2502, a first total energy of passing vehicles within a first frequency range at a reference time may be calculated based on the reference seismic data.

In operation 2503, a second total energy of passing vehicles within a first frequency range at a target time may be calculated based on the target seismic data.

In operation 2503, the road surface condition may be monitored based on the first total energy and the second total energy.

In an embodiment, the method for monitoring a road surface condition with seismic data may comprise of one or more following steps:
(1) Preprocessing of the traffic data, including:
   Noise suppression.
   Resampling.
   Data drift correction.
   Multi-frequency range (f₁ᵢ, f₂ᵢ) bandpass filtering, where f₀<f₁ᵢ<f₁;f₀<f₂ᵢ<f₁; f₀ and f₁ are the lower and upper limit of the sensor's frequency range.
   OneBit filtering.
   Median filtering.
   RMS filtering.
   Smoothing filtering.
   Fourier transform of the traffic vibration data.
   Conjugate of the Fourier transformed data.
   Inverse Fourier transformation.
   Inverse Fourier transformation of the conjugated Fourier transformed data.
   Apply tapering on data in either time or frequency domain, or in both domains.
(2) Using preprocessed, band-limited data, in time domain to compute total energy of the passing vehicles within the chosen frequency range at reference time.
(3) Using preprocessed, band-limited data, in time domain to compute total energy of the passing vehicles within the chosen frequency range at target (or current) time.
(4) Using preprocessed, band-limited data, in frequency domain to compute total energy of the passing vehicles within the chosen frequency range at reference time.
(5) Using preprocessed, band-limited data, in frequency domain to compute total energy of the passing vehicles within the chosen frequency range at target (or current) time.
(6) Calculating the ratio of the total energy in different frequency band computed in (2) and (3)
(7) Calculating the ratio of the total energy in different frequency band computed in (4) and (5)
(8) Applying weighted summation and/or subtraction on the results from (6) and (7).

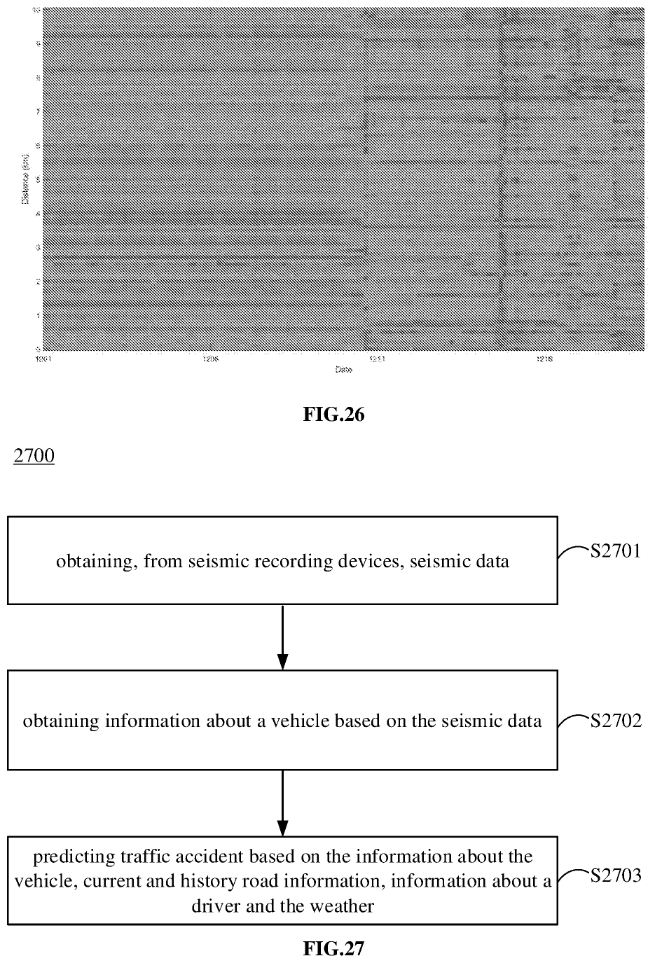

FIG. 26 shows the change of road surface signature response over time.

The change of road surface signature response over time may be observed in FIG. 26.

An embodiment according to the present application provides a method for predicting traffic accident, the method may comprise: obtaining, from seismic recording devices, seismic data; obtaining information about a vehicle based on the seismic data; predicting traffic accident based on the information about the vehicle, current and history road information, information about a driver and the weather.

FIG. 27 is a schematic flowchart illustrating a method for predicting traffic accident according to an example embodiment of the present disclosure.

As shown in FIG. 27, the flowchart 2700 may comprise the following operations.

In operation 2701, seismic data may be obtained from seismic recording devices.

In operation 2702, information about a vehicle may be obtained based on the seismic data.

In operation 2703, traffic accident may be predicted based on the information about the vehicle, current and history road information, information about a driver and the weather.

An embodiment according to the present application provides a method for training a traffic accident prediction model, the method may comprise: obtaining seismic data, information about a vehicle, a road, a driver and a weather when an accident happens; and training the traffic accident prediction model based on the seismic data and the information.

An embodiment according to the present application provides a method for predicting traffic accident, the method may comprise: inputting seismic data to be identified into a traffic accident prediction model for predicting traffic accident to obtain a score for the traffic accident, wherein the traffic accident prediction model is trained using the above method.

An embodiment according to the present application provides a method for training a vehicle weight model, the method may comprise: obtaining a peak for a vehicle from seismic data; and training the traffic accident prediction model based on the peak and a weight for the vehicle.

An embodiment according to the present application provides a method for obtaining a weight of a vehicle, the method may comprise: inputting seismic data to be identified into a vehicle weight model to obtain the weight of the vehicle, wherein the vehicle weight model is trained using the method according to the above method.

Using reconstructed digital traffic flow information and history information to forecast traffic accidents using ML or algorithms, the information includes one or more of the following:
(1) The records of driver's driving experience or years of driving;
(2) Driver's historic accident records;
(3) Driver's abnormal driving records as found by vibration data;
(4) Abnormal road surface conditions;
(5) Road which is under construction or maintenance;
(6) Road with historic accident records;
(7) Sever weather condition, such as snow, storm, hail, rain, wind and fog;
(8) Low visibility;
(9) Traffic flow density;
(10) Vehicle moving path;
(11) Vehicle speed and speed change data;
(12) Vehicle lane change;
(13) Historical road vibration data while accidents happened.

The real-time traffic flow and assist driving may be monitored using the detected vehicles from the above ML models and/or the above methods.

The vehicle moving curves may be generated directly from seismic data via manual picking, automatic picking and ML picking.

An instant vehicle speed may be calculated by using the directly picked moving vehicle curve, wherein the instant vehicle speed is the slope of the vehicle moving curve, v=dx/dt.

An average vehicle speed may be calculated by using the directly picked moving vehicle curve, v=X/T, where X is the distance that the vehicle moved along the road in the time period T.

Using reconstructed digital traffic information to provide traffic warning may comprise:
(1) Accident—by analyzing the abnormal behavior of the traffic data and vehicle moving curves, or vehicle speed spectrum, to provide accident warning.
(2) Overweight vehicle—by determining the weight of the vehicle as described above to determine overload vehicle.
(3) Speeding vehicle—calculated from vehicle moving path, v=d/t, where d is the distance between the sensors, and t is the vehicle moving time between the sensors.
(4) Speeding vehicle from vehicle speed spectrum—from vehicle speed spectrum, to give warning for vehicle speed exceed the speed limit.
(5) Vehicle under the speed limit from vehicle speed spectrum-from vehicle speed spectrum, for vehicle moving at very low speed or under the speed limit, to give the warning.
(6) Sudden stop of a vehicle-finding breakpoint when vehicle moving curve disappears; from vehicle speed spectrum to find significant decreasing in value of the speed spectrum (energy) in the vehicle moving direction or directly from vibration data through processing.
(7) Falling objects from a vehicle—using the signal pattern to find falling object from a moving vehicle hitting the ground from vibration data using ML or analysis.
(8) Irregular driving—using vehicle moving curve, speed and lane information to find irregular lane and speed change within a time window.
(9) Frequent lane changing—analyzing lane information.
(10) Detection of human walking on the highway via signal matching between walking signal and recorded traffic signal along the roadside.
(11) Detection of human walking on the highway using ML model.
(12) Abnormal road condition and sub-road condition by post processing road surface signature response and sub-surface structure change.
(13) Abnormal weather conditions for driving by analyzing road surface signature response and sub-road relative velocity change with time.

An embodiment according to the present application provides an electronic device, the electronic device may comprise: at least one processor; and a memory connected in communication with the at least one processor, wherein the memory stores instructions, when executed by the at least one processor, causing the at least one processor to perform the above methods.

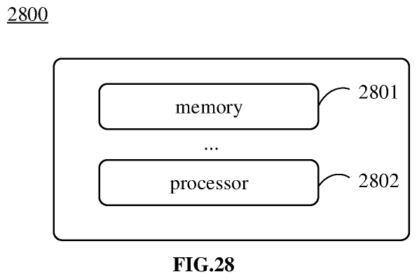

FIG. 28 shows an electronic device according to an example embodiment of the present disclosure.

As shown in FIG. 28, the electronic device may comprise a memory 2801 and at least one processor 2802.

The memory 2801 may be connected in communication with the at least one processor 2802.

The memory 2801 stores instructions, when executed by the at least one processor, causing the at least one processor to perform the above methods.

An embodiment according to the present application provides a non-temporary computer-readable storage medium storing instructions, when executed on a computer, causing the computer to execute the above method.

An embodiment according to the present application provides a computer program product comprising a computer program having instructions, when executed by a computer, causing the computer performing the above methods.

In the embodiment, a calibration vehicle may be used to calibrate the seismic sensors.

Calibration Vehicle—a vehicle for calibrating roadside seismic sensors over time. This is the same or similar vehicle with fixed weight passing through the roadside seismic sensors at a designated speed. The process is repeated weekly or monthly or at any other time interval, and data are analyzed to check if any change occurs. If a systematic amplitude change occurs, then the change will be accounted for in the surface-consistent amplitude correction.

Road and Bridge Quality Assurance—using a calibration vehicle with a designated speed to pass through a road or bridge where seismic sensors are installed, and find any change in the recorded full waveform data over a period of time. If the changes are substantial, it may indicate the change of the road or bridge quality.

Although a plurality of components are shown in the above various block diagrams, those skilled in the art should understand that embodiments of the present disclosure may be implemented in the absence of one or more components or in combination with certain components.

Although the steps have been described above according to the order shown in the drawings, those skilled in the art should understand that the steps may be performed in a different order, or embodiments of the present disclosure may be implemented without one or more of the above steps.

It may be understood from the foregoing that the electronic components of one or more systems or devices may include, but are not limited to, at least one processing unit, a memory, and a communication bus or communication device that couples various components including the memory to the processing unit. The system or device may include or access to a variety of device-readable media. System memory may include device-readable storage media in the form of volatile and/or non-volatile memory (for example, read-only memory (ROM) and/or random access memory (RAM)). By way of example, and not limitation, system memory may also include operating systems, application programs, other program modules, and program data.

Embodiments may be implemented as a system, method or program product. Therefore, the embodiments may take the form of an all-hardware embodiment or an embodiment including software (including firmware, resident software, microcode, and the like), which may be collectively referred to herein as “circuits”, “modules”, or “systems”. In addition, embodiments may take the form of a program product embodied in at least one device-readable medium on which device-readable program code is embodied.

A combination of device-readable storage media may be used. In the context of this document, a device-readable storage medium (“storage medium”) may be any tangible, non-signaling medium that may contain or store a program composed of program code configured to be used by or in combination with an instruction execution system, apparatus, or device. For the purposes of this disclosure, storage media or devices should be interpreted as non-transitory, that is, excluding signal or propagation media.

Although the present invention has been described in connection with the embodiments of inventive concepts illustrated in the accompanying drawings, it will be understood to those skilled in the art that various changes and modifications may be made without departing from the technical spirit and essential feature of inventive concepts. It will be apparent to those skilled in the art that various substitution, modifications, and changes may be thereto without departing from the scope and spirit of the inventive concepts. Accordingly, all such modifications are intended to be included within the scope of the present invention as defined in the claims.

1. A method for monitoring traffic flow with seismic data, the method comprising:
obtaining, from seismic recording devices, the seismic data;
obtaining a seismic data fluctuation graph based on the seismic data, wherein the seismic data fluctuation graph comprises a plurality of seismic data fluctuation curves for each of the seismic recording devices; and
monitoring the traffic flow based on the seismic data and/or the seismic data fluctuation graph.

2. The method according to claim 1, wherein the seismic recording devices are arranged at a fixed or variable interval on one side of a road, on both sides of the road, or in the middle of the road or any combination thereof.

3. The method according to claim 1, wherein the obtaining of the seismic data fluctuation graph based on the seismic data comprises:
performing a signal enhancement on the seismic data.

4. The method according to claim 3, wherein the obtaining of the seismic data fluctuation graph based on the seismic data further comprises:
performing a two-way traffic wavefield separation or attenuation on the seismic data after the signal enhancement.

5. The method according to claim 4, wherein the obtaining of the seismic data fluctuation graph based on the seismic data further comprises:
performing balancing on the seismic data by using a correction curve after the two-way traffic wavefield separation or attenuation; and
obtaining the seismic data fluctuation graph based on the balanced seismic data.

6. The method according to claim 1, wherein the method further comprises:
obtaining a vehicle speed spectrum based on the seismic data and/or the seismic data fluctuation graph, wherein the vehicle speed spectrum is used to visually display a motion status of a vehicle.

7. The method according to claim 6, wherein the method further comprises:
determining a vehicle speed and/or a vehicle moving path for the vehicle based on the similarity between seismic data from different seismic recording devices.

8. The method according to claim 7, wherein the method further comprises:
determining whether the vehicle is overspeed based on the vehicle speed.

9. The method according to claim 1, wherein the method further comprises:
determining a type and a weight of a vehicle based on a peak for the vehicle in each of plurality of seismic data fluctuation curves.

10. The method according to claim 7, wherein the method further comprises:
determining whether the vehicle is stopping based on the vehicle moving path.

11. The method according to claim 1, wherein the method further comprises:
determining whether there is a pedestrian walking on the road based on the seismic data.

12. The method according to claim 1, wherein the method further comprises:
detecting whether there is an object falling from a vehicle based on the seismic data.

13-33. (canceled)

34. An electronic device comprising:
at least one processor; and
a memory connected in communication with at least one processor,
wherein the memory stores instructions, when executed by at least one processor, causing at least one processor to perform the method of claim 1.

35. A non-temporary computer-readable storage medium storing instructions, when executed on a computer, causing the computer to execute the method according to claim 1.

36. (canceled)
